(19) United States
(12) Patent Application Publication
(10) Pub. No.: US 2007/0126298 A1
(43) Pub. Date: Jun. 7, 2007

(54) Device for angularly positioning a starter cylindrical head with respect to the support thereof

(75) Inventors: Marcos De Godoy, Americana, Sp (BR); Marius Drozdek, Villette D'Anthon (FR)

Correspondence Address: OSHA LIANG L.L.P., 1221 MCKINNEY STREET, SUITE 2800, HOUSTON, TX, 77010, US

(73) Assignee: Valeo Equipements Electriques Moteur, Creteil (FR)

(21) Appl. No.: 10/558,549

(22) PCT Filed: Jun. 1, 2004
(86) PCT No.: PCT/FR04/01341

§ 371 Date: Feb. 14, 2007

(30) Foreign Application Priority Data
May 30, 2003 (FR) 03/06563

(51) Int. Cl. F02N 15/06; F02N 11/00; H02K 5/10

(52) U.S. Cl. 310/88; 74/6; 74/7 R; 290/38 R; 310/89

(57) ABSTRACT

The inventive device for angularly positioning a starter on a support (11) interfacing with a thermal combustion engine for a motor vehicle comprises indexing means, at least one projection (12) which is axially connected to the cylindrical head (10) and introducible into a complementary slot (13) arranged in the support (11) in order to form an indexing area (14) for fixing and angularly orienting a rotational inductor coil with respect to the support (11) without increasing radial thickness thereof. In such a manner, the angular indexing function is transferred to the interfacing support (11). The projection (12) is separated from the slot (13) by a clearance in order to form an outlet orifice (21) enabling water to be evacuated from the starter.

### TECHNICAL FIELD OF THE INVENTION

The invention relates to a device for angularly positioning a starter on an interfacing support with a thermal combustion engine of a vehicle, and comprising means for indexing constructed on a tubular cylindrical head of an electrical motor inductor coil and the support in such a way as to immobilize a rotational inductor coil, and to angularly orientate the inductor coil with relation to the support.

### PRIOR ART

A starter for a vehicle is comprised of several sub assemblies, comprising an electrical engine, a control contactor, and a motor starter associated with the drive sprocket of the sprocket wheel of the vehicle. The contactor has a dual function of powering the electrical engine in current issued from the battery, and activating a lever for the axial displacement of the motor starter to an active position for the drive sprocket. The electrical engine is comprised of a fixed inductor coil forming the stator, and a rotating armature comprising the rotor coupled to the motor starter. The inductor coil is equipped with a metal tubular cylindrical head, which has either permanent magnets or field coils housed in a magnetic circuit.

The starter is fixed to the thermal combustion engine of the vehicle through a support used as an interface and a mounting flange. The electrical engine of the starter is positioned on the support through the cylindrical head comprising the outer envelope of the electrical engine. The fixation of the electrical engine on the support is achieved by means of tie rods formed by the large longitudinal screws screwed on the support.

The cylindrical head of the electrical engine comprises a tubular envelope indexed in rotation with relation to the support. The indexing of the cylindrical head allows the following functions to be obtained:
Immobilization in rotation of the inductor coil, which must hold against the torque of the engine and the vibrations;
precise angular orientation of the tie rods with relation to the support;
precise angular orientation of the supply cable between the contactor and the electrical engine collector;
precise orientation of the internal members of the electrical engine with relation to the other support side pieces (lever, various reliefs).

Different types of indexings are used in starters of the prior art.

In a first type of known indexing, the cylindrical head comprises a U-shaped slot that fits axially into an index projecting from the support. This index may make a one-piece part of the support, or be comprised of an intermediate piece transferred to the support. The index integral with the support has a fixed and immobile angular position with relation to the support. An adjustable angular position of the cylindrical head with relation to the support is therefore impossible, which may constitute a disadvantage depending on the position of the bracing fixation rods of the starter on certain thermal engines.

The change in the angular position of the tie rods necessitates another cylindrical head part number, with the risk of disturbing throughput following part number changes. These part number changes involve specific tools, and therefore additional costs. On the other hand, the index projecting from the support considerably disturbs the internal machining operations of the support or the bearing face of the cylindrical head on the support.

In a second type of known indexing, the cylindrical head comprises a radial protuberance that is axially housed in a radial slot of the support. This slot is generally integrated to the support, and creates an exterior added thickness to the support that may disturb the support environment on the thermal engine.

### OBJECT OF THE INVENTION

An object of the invention is to provide a device for predetermined angular positioning of the cylindrical head of the electrical engine with relation to the starter support, by using a standard cylindrical head, and smaller dimensions at the level of the indexing area.

The device according to the invention is characterized in that the indexing means comprises at least one axial projection forming an integral part with the cylindrical head, and designed to be engaged in a complementary slot disposed in the support to create an indexing area without radial added thickness. The use of an axial indexing projection does not create radial added thickness, allowing the benefit of smaller dimensions at the level of the indexing area of the cylindrical head in the support.

The angular orientation function is transferred to the interfacing support having one or more receiving slots for the axial projection. The slot(s) is or are integrated in the circular contact of the support.

According to a preferential embodiment, the projection is separated from the slot by a clearance to create an outlet orifice enabling water to be evacuated from the starter. Water evacuation is performed either through a baffle, or directly through the outlet orifice. Such a device prevents the formation of a special evacuation orifice in the cylindrical head or in the support.

### SHORT DESCRIPTION OF THE DRAWINGS

Other advantages and characteristics will emerge more clearly from the description that will follow of an embodiment of the invention given by way of a non-limiting example, and represented in the attached drawings in which:

FIG. 1 is an exploded view in perspective of the cylindrical head and the support of a starter equipped with the indexing device according to the invention;

FIG. 2 shows a view that is identical to FIG. 1, after assembly of the cylindrical head on the support;

FIG. 3 represents a plan view of FIG. 2;

FIG. 4 is a sectional view according to line 4-4 of FIG. 3;

FIGS. 5 to 8 illustrate partial views of FIG. 4 of different variations of embodiment utilizing the indexing area to create the evacuation of water likely to accumulate within the starter.

### DESCRIPTION OF A PREFERRED EMBODIMENT

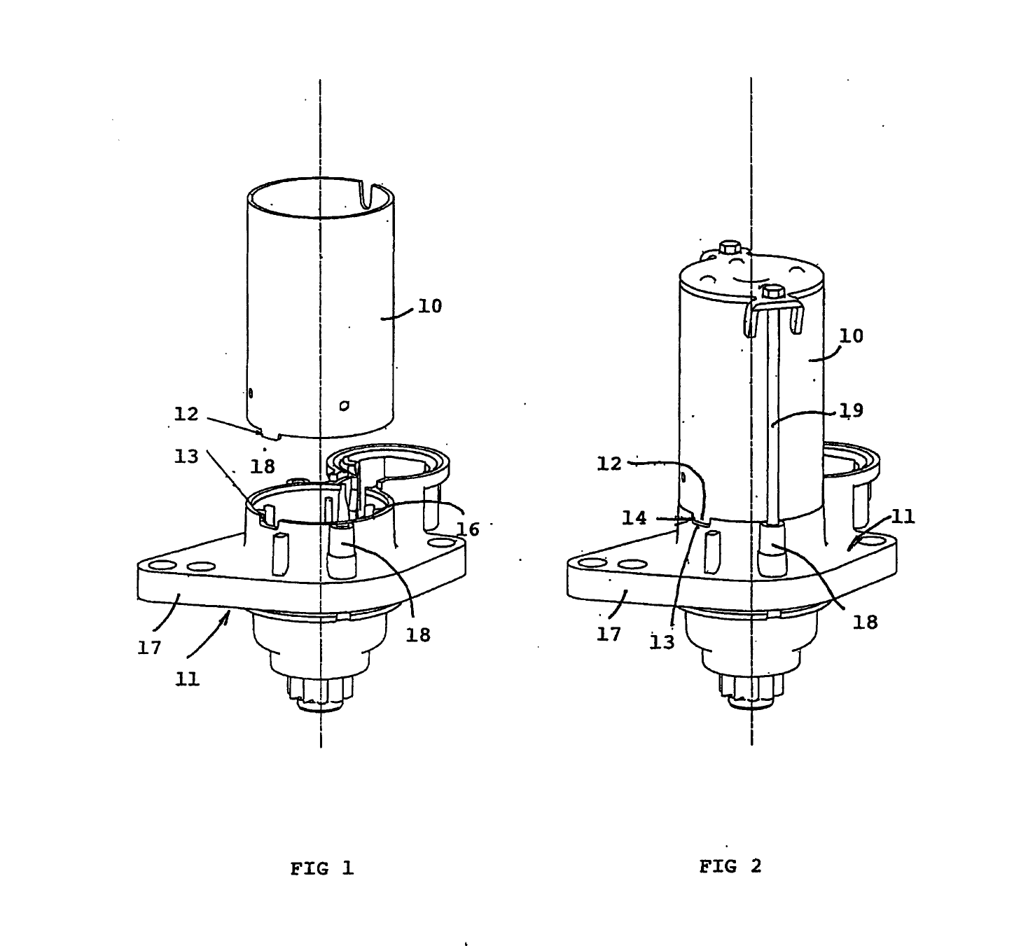

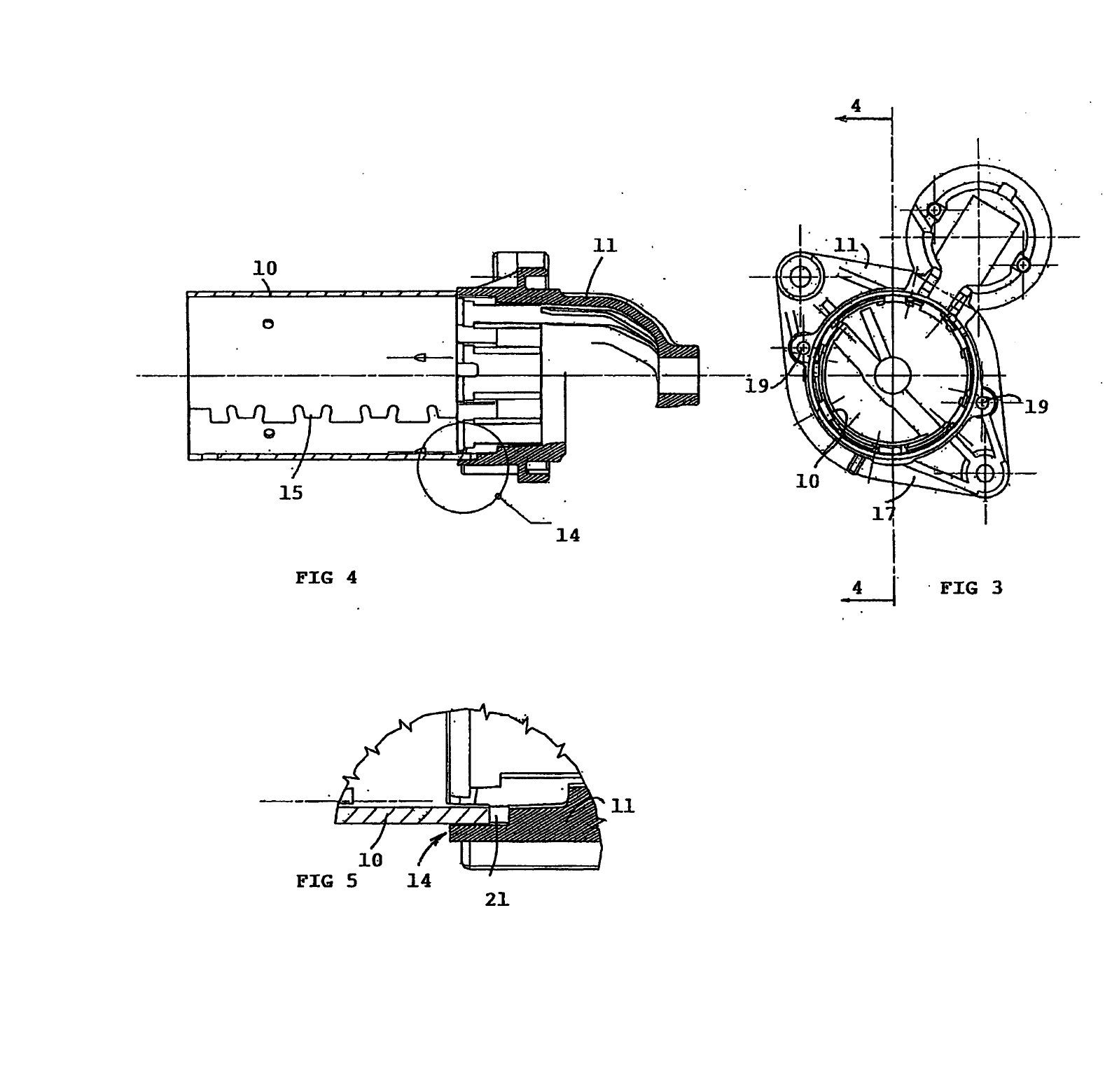

In FIGS. 1 to 4, the angular positioning of the cylindrical head 10 of the electrical engine with relation to the interfacing support 11 between the starter and the thermal engine of the vehicle, is assured by an axial projection 12 of the cylindrical head 10 and is designed to be engaged by sliding in a slot 13 of the support 11 to create an indexing area 14.

The projection 12 is constructed on one of the frontal sides at the bottom of the cylindrical head 10, and is presented, for example, in a substantially rectangular profile having a length of several millimeters projecting from the frontal side by extension according to a direction parallel to the axis of the cylindrical head 10. The axial projection 12 is obtained during the cutting and rolling of a metallic sheet in low carbon steel comprising the cylindrical head 10. After rolling, the two longitudinal extremities of the sheet are assembled to each other by stapling means 15 (FIG. 4).

The cylindrical head 10 is therefore a standard piece for all electrical engines of the same power, the modification in orientation being obtained by the angular position of the slot 13 in the circular contact 16 of the support 11. This standardization of the cylindrical head for different types of electrical starters of the same power allows the cost of manufacturing such a starter to be reduced considerably. The angular orientation function is transferred to the interfacing support 11, wherein the mounting flange 17 is already specific to each type of combustion engine block. The slot 13 integrated in the contact 16 of the support 11 does not form added radial thickness for the reception of the axial projection 12. This results in smaller dimensions at the level of the indexing area 14 of the cylindrical head 10 in the support 11.

The mounting flange 17 of the support 11 comprises diametrically opposed tapped housings 18 for the reception of a pair of tie rods 19 at threaded extremities designed to connect the electrical engine to the support 11. It is observed that the indexing area 14 is angularly offset from the housings 18 by angular sectors specific to each type of engine block. The indexing and fixation functions are separated from each other, improving the mounting operations of the starter.

It is clear that the support 11 may be equipped with several slots 13 offset angularly at predetermined intervals in the contact 16. According to the desired angular orientation function, the projection 12 of the cylindrical head 10 will be introduced in one of these slots 13.

The water tightness of a starter is not total, with reference to the presence of different openings in the cylindrical head of the electrical engine, having as functions:
the evacuation of foreign bodies, particularly dust, infiltration water and condensation internal to the apparatus;
the ventilation and breather vent of the electrical engine; any rotating machine in operation creates air circulation and therefore the possibility of internal positive pressure.

The simplest case consists of providing an outlet orifice in the cylindrical head of the electrical engine. The orifice is positioned at a low point of the starter mounted in position on the vehicle, in such a way as to enable the direct natural evacuation of water by the effect of gravity.

With reference to FIGS. 5 to 8, the indexing area 14 according to the invention may also be constructed to evacuate water that may penetrate the starter accidentally, particularly on the occasion of the projection of water during rolling of the vehicle on a wet road, or washing by high pressure jet. It suffices to provide a slight clearance forming an orifice 21 between the projection 12 and the slot 13 to achieve this additional function.

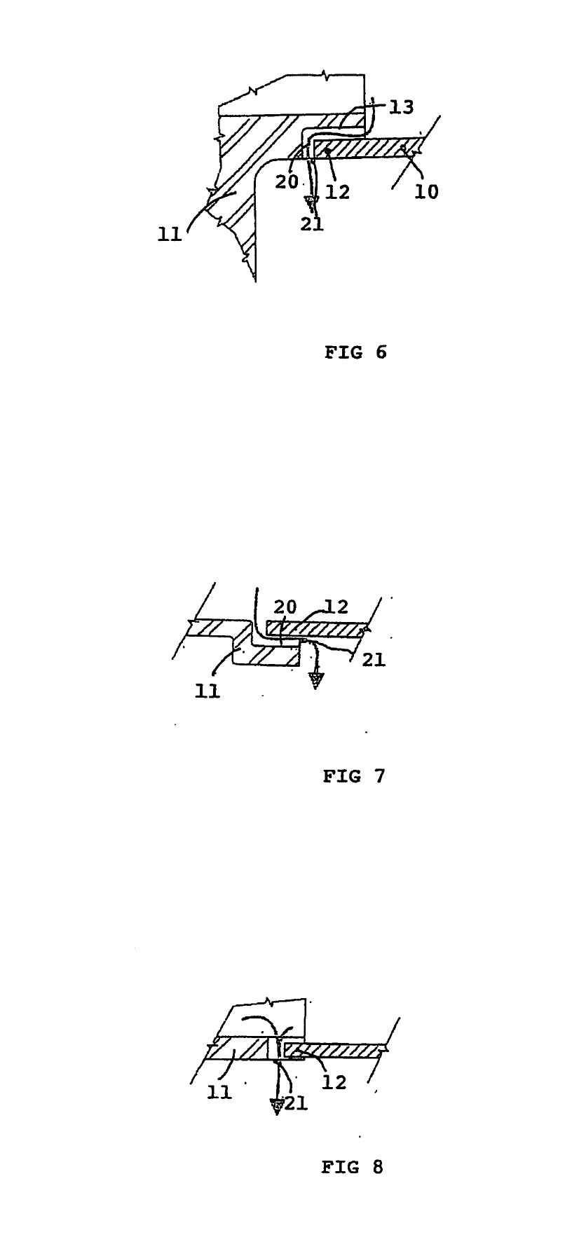

In FIGS. 5 to 7, the evacuation of water to the exterior is performed through a baffle 20 by providing a clearance in the axial and radial direction and between the projection 12 and the slot 13. The outlet orifice 21 is axial on the device of FIG. 5 or 7, and radial in FIG. 6 or 8.

Therefore, the mounting clearance between the projection and slot presents the advantage of not using the supplementary piece in the form of a baffle that complicates the mounting process of the starter and leads to additional costs.

In FIG. 8, the evacuation is direct through the outlet orifice 21 delimited by the axial clearance between the extremity of the projection 12 and the bottom of the slot 13.

1. A device for angular positioning of a starter on an interfacing support (11) with a thermal combustion engine of a vehicle, and comprising means for indexing constructed on a tubular cylindrical head (10) of an inductor coil of the electrical engine, and the support (11) in such a way as to immobilize the inductor coil in rotation, and to angularly orient the inductor coil with relation to the support (11), characterized in that the indexing means comprises at least one axial projection (12) integral with the cylindrical head (10), and designed to be engaged in a complementary slot (13) provided in the support (11) for creating an indexing area (14) without radial added thickness.

2. The angular positioning device according to claim 1, characterized in that the angular orientation function is transferred to the interfacing support (11) having one or more slots (13) for receiving the axial projection.

3. The angular positioning device according to claim 1, characterized in that the slot (13) is integrated in the circular contact (16) of the support (11).

4. The angular positioning device according to claim 1, characterized in that the projection (12) is separated from the slot (13) by a clearance to create an outlet orifice (21) enabling water to be evacuated from the starter.

5. The angular positioning device according to claim 4, characterized in that the water evacuation is performed through a baffle (20).

6. The angular positioning device according to claim 4, characterized in that the water evacuation is direct through the outlet orifice (21).
